(19) United States
(12) Patent Application Publication
(10) Pub. No.: US 2008/0145625 A1
(43) Pub. Date: Jun. 19, 2008

(54) SUBSTRATE, INCLUDING AT LEAST ONE FULL OR PARTIAL SURFACE MACRO-STRUCTURED LAYER, METHOD FOR PRODUCING SAME AND ITS APPLICATION

(76) Inventors: Jorg Schumacher, Kornwestheim (DE); Inka Henze, Nieder-Olm (DE); Todd Gudgel, Morton Grove, IL (US); Gabriele Romer-Scheuermann, Ingelheim (DE)

Correspondence Address: Todd T. Taylor;Taylor & Aust, P.C., 142 S. Main Street, P.O. Box 560, Avilla, IN, 46710, US

(21) Appl. No.: 12/022,293

(22) Filed: Jan. 30, 2008

Related U.S. Application Data
(63) Continuation of application No. PCT/EP2006/006856, filed on Jul. 13, 2006.

(30) Foreign Application Priority Data
Aug. 3, 2005 (DE) 10 2005 036 427.6

(51) Int. Cl. B32B 9/00; B41M 5/00; B05D 1/32; B05D 3/02; B32B 9/04

(52) U.S. Cl. 428/195.1; 428/411.1; 427/372.2; 427/282; 427/272

(57) ABSTRACT

A method for producing a substrate including a layer includes providing that the layer is a full or a partial surface macro-structured layer, applying a sol-gel solution in already structured form onto the substrate, and drying and/or baking, resulting in a sol-gel layer.

### CROSS REFERENCE TO RELATED APPLICATIONS

This is a continuation of PCT application No. PCT/EP2006/006856, entitled “SUBSTRATE COMPRISING AT LEAST ONE ENTIRE SURFACE OR PARTIAL SURFACE MACROSTRUCTURED LAYER, METHOD FOR THE PRODUCTION THEREOF AND ITS USE”, filed Jul. 13, 2006, which is incorporated herein by reference.

### BACKGROUND OF THE INVENTION

1. Field of the Invention

The invention relates to a substrate, including at least one full- or partial surface macro-structured layer, a method for producing same and its application.

2. Description of the Related Art

In the production of many functional layers or layer systems, especially when glasses and glass ceramics are used as substrate materials, the sol-gel technology is often used. The following are examples of such sol-gel layers:

| | | Examples of used |
|---|---|---|
| Function of layers: | Layer/Layer system | sol-gel-solutions |
| anti-reflex | multi-layer system: | alcoholic Si—and Ti— |
| | SiO₂—TiO₂ | alcoxide solutions |
| photocatalytic | TiO₂ layer (anatase) | Colloidal TiO₂-solution |
| anti-microbial | Ag containing layer | Colloidal Ag-solution |
| decorative | Colored SiO₂-layer | SiO₂-sol containing |
| | | colorants or pigments |
| easy-to-clean | hydro-silconized glass | Solution containing |
| | surface containing | Fluor alkyl siloxanes |
| | hydrophobic | |
| | carbon side chains | |
| Electrochromic | WO₃-layer on | Alcoholic WO₃-sol |
| | TCO-coated | |
| | substrate | |

Depending upon individual applications the used sol-gel solutions will have different viscosities. Many times however, it will be in the range of aqueous solutions, therefore being very low. Application of the layers is normally done over the full surface by using application methods such as immersion, flooding, spray coating, atomizing, pouring, coating, roll coating or casting. As a rule the layers are cured through a subsequent temper step.

The structuring of such functional layers presents a special challenge since the conventional printing processes such as offset or screen printing fail in these instances due to the low viscosities of the associated solutions. However, the provision of colored, transparent layers on glass substrates with the assistance of digital printing technology is known. This may for example originate from SiO₂-sols which contain organic colorants.

In addition, there are already some suggestions within the current state of the art for the application of structured sol-gel layers.

According to WO 97/38810 A1 a method for the production of a sintered structure on a substrate is described, whereby a particle-containing liquid such as a sol-gel solution is applied onto a substrate by way of an ink jet printer and whereby the applied liquid evaporates by way of a laser impulse, thereby building up a sintered structure layer by layer.

WO 02/17347 A1 discloses a method for solidifying and structuring of a sol-gel composition on a surface of a substrate, whereby a layer of a sol-gel composition is discharged on a surface of a substrate. An electron beam is directed onto selected areas of the sol-gel film in order to cure the sol-gel film. The non-cured areas are removed with a solvent.

In addition, EP 0 329 026 A1 refers to an ink jet ink and an associated printing method, whereby the ink comprises 90 to 99.9 weight % of an aqueous sol-gel medium—preferably a mixture of carrageenen and water, as well as 0.1 to 10 weight % of a coloration medium—and the ink constitutes a thermally reversible convertible sol-gel ink which is a gel at ambient temperature and a sol at temperatures of between approximately 40° C. and 100° C. The ink is applied as a sol onto the substrate where it forms a gel when cooling. The used substrate is practically exclusively paper into which the ink penetrates.

The disclosure in U.S. Pat. No. 5,970,873 relates to an imaging method including an image-like application of a mixture of a sol-precursor and a liquid as a thin layer onto a substrate and removal of the liquid from the thin layer, in order to form image-like an insoluble, cross-linked polymeric sol-gel matrix. Also, an imaging element—for example a printing plate for lithographic printing—which is produced by the method is described. The image area created in the sol-gel matrix therefore, serves as “negative” onto which the printing ink is applied and which is then transferred to a suitable receiving material in order to reproduce the image.

In addition, WO 99/33760 discloses a method for the provision of an object having visually noticeable patterns, whereby initially at least one surface area of one substrate is masked and whereby then at least one thin layer is applied onto the masked and the unmasked areas of the surface and whereby the mask is then again removed in order to produce the desired pattern. The hereby created object exhibits at least one first section which includes a generally transparent thin film, selected from metalliferous, metalloid-containing coatings and combinations thereof which, when viewed under reflective light shows a first color and under penetrating light shows a second color. It also exhibits a second section which clearly differs in contrast from the first. The sol-gel technology is mentioned; however, no explanations of any kind are given as to how this can be accomplished.

Finally, DE 100 19 822 A1 describes a lift-off method for micro-structuring thin layers, whereby a mask is applied onto a substrate which has recesses at the locations that are to be coated. A sol is applied over the entire area of the substrate which is covered by the mask. The sol-film is cured. The mask, together with the hardened sol that is present on the mask surface is removed and the hardened sol film is transferred into the desired solids state by way of supplying energy. A component such as a semiconductor component produced by this process which is provided with a micro-structured thin layer is also described.

What is needed in the art is an as flexible as possible, non-consumptive and inexpensive method with which structures on a substrate may be produced in a simple manner, especially any substrate being provided with a desired structure.

### SUMMARY OF THE INVENTION

The present invention provides an as flexible as possible, non-consumptive and inexpensive method with which structures on a substrate may be produced in a simple manner, especially any substrate being provided with a desired structure.

The invention in one form is directed to a method for producing a substrate including a layer. The method includes providing that the layer is a full or a partial surface macro-structured layer. The method further includes applying a sol-gel solution in already structured form onto the substrate. The method further includes drying and/or baking, resulting in a sol-gel layer.

The invention in another form is directed to a method for producing a substrate including a layer. The method includes providing that the layer is a full or a partial surface macro-structured layer and structuring a sol-gel layer which has been applied to the substrate, by using a masking lacquer.

The invention in yet another form is directed to a substrate including at least one full or partial surface macro-structured layer obtained by structuring a sol-gel layer that was applied onto the substrate using a masking lacquer.

### DETAILED DESCRIPTION OF THE INVENTION

The present invention provides a substrate, including at least one full or partial surface macro-structured layer, obtained through a method (a):
Application of a sol-gel solution in already structured form onto a substrate; and
Drying and/or baking, resulting in a sol-gel layer;
   Or a method (b):
structuring of a sol-gel layer which is applied onto a substrate by way of using a masking lacquer.

Subject matter of the invention also includes 3 method variations for the production of the inventive substrate which, according to variation (a) includes the following steps:
Application of a sol-gel solution in structured form onto the substrate; and
Drying and/or baking resulting in a hardened sol-gel layer.

The inventive method according to method variation (b1) includes the following steps:
(1) Application of a masking lacquer onto a substrate, either in already structured form or by producing a structure in the masking lacquer after application;
(2) Application of a sol-gel solution;
(3) Drying of the sol-gel solution, resulting in a dried sol-gel layer;
(4) Removal of the masking lacquer by mechanical, chemical or pyrolytic ways; and
(5) Optional baking of the dried sol-gel layer resulting in a hardened sol-gel layer.

The inventive method variation (b2) includes the following steps:
(1) Application of a sol-gel solution onto a substrate and producing a sol-gel layer through evaporation of the solvent; and optional baking of the dried sol-gel layer, resulting in a hardened sol-gel layer;
(2) Application of a masking lacquer onto the sol-gel layer, either in already structured form or by producing a structure in the masking lacquer after the application;
(3) Removal of the sol-gel layer on the exposed areas which are not covered with masking lacquer, especially with a chemical caustic solution;
(4) Removal of the masking lacquer with mechanical, chemical or pyrolytic ways; and
(5) Optional baking of the structured, dried sol-gel layer, resulting in a hardened sol-gel layer, if not already accomplished in step (1).

The current invention therefore includes substrates with a structured coating, whereby a sol-gel solution is used to produce the structured coating. In accordance with the invention the term “structure” is to be interpreted as liberally as possible and includes for example a design, logo, image(s), words, a marking, hatchings, distinguishing marks, inscriptions in one or in various defined optical forms, functionalities or similar. This structure may be provided on the full or partial surface on a substrate.

The basis for the structure is a sol-gel system, in other words a sol which, after drying forms a thin, preferably transparent gel film which preferably hardens through baking/temper hardening. In the present invention the term “sol-gel layer” is to be understood to be a layer, which was produced by a sol-gel process.

Here, so-called nanosols may also find an application. The average particle diameter of such sols is in the range of <800 nm, preferably <200 nm, especially preferably <100 nm.

The sol-gel layer is based on one or more metal oxides and is selected preferably from at least one titanium-, zircon-, silicon-, aluminum-, tin-, boron- or phosphorous oxide or mixtures thereof. It is especially preferred if silicon oxide is contained. However, other or additional metal oxides may also be used. Within the scope of the invention the term “metal” also includes metalloids, for example silicon and germanium.

In accordance with the current invention so-called classic sol-gel solutions are used as “sol-gel solutions”. In addition to a suitable amount of desired additives they contain or consist of a metal oxide-precursor, a solvent, an insignificant amount of water for pre-condensation and a catalytic converter (acid or base). In addition colloidal metal oxide solutions=solutions of nanosize metal oxide powders are used in water or in other solvents; in some instances nanosized metal oxide powders are also added to classic sol-gel solutions. Solvents are generally water or aqueous/organic solvents, for example ethanol or acetone. Long-time stable sol-gel solutions can preferably also be stored in purely organic solvents. These sols are clear and stable solutions which generally have a solids content in the range of approximately 1 to approximately 30 weight %. However, the metal oxide contents may also be distinctly higher. To produce a coating, a part of the solvent is evaporated, causing the particles to chemically or physically aggregate, thereby producing a three-dimensional cross-linkage (gelling). After complete evaporation of the solvent a solvent-free coating of a porous sol-gel layer occurs, which further interlocks under the influence of higher temperatures, thereby hardening and compressing.

The sol-gel matrix may also be modified as desired chemically through Co-hydrolysis or Co-condensation. These modifications are known to the expert. Organically modified sol-gel compositions of this type are known, for example under the trademark ORMOCER®.

In principle, the sol-gel coating may occur directly in structured form according to the inventive method variation (a) by utilizing various printing techniques. Special reference is made in this context to digital-, tampon- and rotogravure printing, since these are especially suitable for the processing of low viscous liquids.

In addition, full surface coating of the object is possible, whereby the structuring of this coating occurs in additional steps, as a rule by utilizing masking lacquers according to the inventive method variations (b1) and (b2).

In accordance with a first inventive variation (a) the sol-gel solution which is converted into the sol-gel layer may be applied directly in a structured form onto the substrates.

Structured types of liquid coating can generally be applied to the substrate by utilization of known printing technologies. However, this has hitherto not been known for sol-gel solutions which are utilized to produce functional layers. Conventional sol-gel solutions dry very quickly which may cause significant difficulties in printing techniques. Without a modification to the solution, especially to the solvents, many processes are not usable since the coating reacts on the transfer medium or in the print nozzles. It is important that no/hardly any condensation reaction occurs during the printing process. In contrast to the current state of the art the current invention provides methods with which even known printing technologies may be used, whereby the aforementioned problems are reduced to a minimum or are avoided altogether.

Printing technologies which hitherto could not be used become accessible for the first time through utilization of sol-gel solutions that were tailor-made for the specific printing technology and which, for example include a modification of the solution's viscosity and/or a suitable choice of solvent.

In pigment-filled systems for example, a high-viscosity sol-gel solution can be used for screen printing. However, for digital printing a low-viscosity solution is desirable.

Since sol-gel solutions as a rule possess a comparatively low viscosity, digital-, tampon- and rotogravure printing are especially suitable for producing structure-coated objects. The application of the sol-gel solution onto the substrate in already structured form according to the inventive method (a) is therefore implemented preferably in a known printing process, with a low-viscosity sol-gel solution. In the context of the current invention the term “low viscosity” is to be understood to be a viscosity in the range of approximately 0.1 to approximately 10⁴ mPa s.

When using the digital printing technique, the airbrush-technology (resolution 42 dpi) and the ink-jet technology (resolution approximately 1400 dpi) are especially suitable. The piezo-technique is preferred in contrast to the bubble variation, since with said technique the sol-gel solutions are not subjected to any temperature stresses which can lead to hardening of the sols. In contrast to 4-color printing only one sol-gel solution is generally required in accordance with the invention in order to produce functional layers.

If structured layers, especially substrates with structured layers, for example decorative color layers are to be produced on a sol-gel basis, pigment-filled color formulations are preferably utilized which contain a sol-gel solution, for example in the form of a fixing agent. Depending upon the selected ratio of pigment to fixing agent (incl. solvent) as well as possibly added thickening additives, a very high viscosity can be selected in the formulation. Thickening additives of this type are for example cellulose, cellulose ether, starch, aerosils (pyrogenic silicic acids), bentone, hydrophobic modified polyoxyethylenes, acrylates, polyurethanes, polyamides, polyolefins, castor oil and basic sulfonates.

When thickening additives are added resulting in a highly viscous, sufficiently thixotrope sol-gel solution, application of the structured coating can also be accomplished with screen printing and other printing techniques, such as offset-, letterpress and tampon printing. “Highly viscous”, “sufficiently thixotrope” sol-gel solution in this instance is to be understood that the viscosity—in the absence of shear forces—is above a limit of approximately 10³ mPa s, especially approximately 10⁴ to 10⁶ mPa s. Thixotropy describes the characteristic of a non-Newtonian fluid showing a low viscosity following a shearing action and to reconstitute again at standstill.

In contrast to U.S. Pat. No. 5,970,873 no “negative” image which then serves as the basis for the production of a “positive” image is produced in the current invention (variation a). Instead, a positive structure is produced immediately. The inventive substrate, including a structure is not an image element and there is no image-like application of a sol-precursor, meaning that the utilization does not principally serve the production of lithographic printing plates. In addition, the ether or ester of the metal oxide which is used as sol does not need to support at least one “melanophile” side group.

In accordance with additional inventive variations (b1) and (b2), the sol-gel layer can be applied to the full substrate surface and can subsequently be structured in additional process steps.

The structuring of full-surface coating is generally accomplished with the use of masking lacquers. These can be utilized in two different ways according to the two method variations (b1) and (b2) of the invention.

According to one inventive variation they can be applied as positive lacquers directly onto the substrate at the locations of the layer that are to be structured (inventive method variation (b1)). Preferably printable masking lacquers are used in this instance (screen printing). In this instance the application of the masking lacquer may preferably already occur in structured form.

Alternatively, a photo resist can be used. In this instance the structuring may also occur in a second step after a full-surface application of the photo, with the assistance of an exposure step and subsequent removal of the areas that are not to be lacquered. Subsequently the full-surface coating of the prepared substrate occurs, utilizing the sol-gel solution. The use of (screen-) printable lacquers as compared to photo resists is preferred, since they are clearly more cost effective and their application is associated with clearly a lesser expenditure.

Any desired solvent or disperging agent or solvent mixture that is suitable for such a process may be used as solvent or disperging agent for the sol-gel solution of all inventive methods. Examples are water and alcohols, for example ethanol or alcohol-water mixtures. For example alcohols, but also aprotic solvents such as dioxin or aqueous solvents can be used to produce sol-gel coatings on a silicone oxide basis.

The inventively applied sol-gel layers which are utilized in the inventive method variations (b1) and (b2) have a preferred layer thickness in the range of 1 nm to 110 μm, preferably 1 nm to 1 μm, especially 1 to 200 nm. Depending upon the function, the (preferred) layer thickness varies greatly. If, in the case of an easy to clean layer only several mono-layers are deposited on the substrate—in other words, the layer thickness in this instance moves in the nm-range—it may be preferred if pigment-filled, decorative sol-gel layers are applied to be vision impervious. This is accomplished, for example with layer thicknesses of at least 10 μm or distinctly above.

If a full or partial surface layer is to be applied this is preferably done in a spray or immersion process, whereby however all other methods known to the experts may also be utilized, for example casting, roll coating (rollers), coating, pouring or doctoring.

In accordance with the invention sol-gel layers are preferred which fulfill very specific functions which can be used for commercial products. Drying in accordance with method variation (b1) preferably occurs in a temperature range of ambient temperature (25° C.) to 300° C. until essentially all solvent is removed, whereby water, alcohol, solvents known to the expert, especially current, preferably halogen-free, low-boiling (boiling point: to 120° C.) and high-boiling solvents (boiling point: 120° to 250° C.) and mixtures are preferred. The drying time is generally in the range of a few minutes to 1 or more days. In some application examples the quality of the hereby formed layers is sufficient, so that no further production step for baking is necessary. No preferred drying times can be cited, since these can vary greatly depending upon the application.

After drying of the sol-gel layer, the masking lacquer is removed. This can be accomplished through mechanical ways such as stripping, wiping off, brushing off, chemical ways such as dissolving with the assistance of a solvent or water, acids or caustic solutions, or through the use of pyrolytic ways.

In most application instances the dried sol-gel layer is subsequently baked. Within the scope of the current invention “baking” ways according to variation (b1) that the dried sol-gel layer is transferred into its final form through chemical reaction, sintering and/or stimulation of diffusion processes. To accomplish this the substrate with the applied, dried layer is subjected to a temperature in the range of between ambient temperature and 800° C., preferably between 250 and 800° C. for a time of between 10 minutes to 3 hours.

As a rule, masking lacquers cannot be subjected to the temperatures necessary for hardening of sol-gel layers, so that these have to be removed prior to baking.

Baking offers the advantage of the mechanical and chemical stability of the layer being drastically increased. In some instances the layer receives its actual desired function only through the baking process. In these instances the coated object becomes only usable in its specific application after the baking step is completed.

Baking also enables a targeted influence over certain characteristics of the layer. For example the optical antireflection effect of SiO2-TiO2 alternating (anti-reflex) layer systems depends decisively on the refractive index of the specific individual layers contained in the layer package. This in turn is structure-dependent. The chemical structure adjusts itself differently, depending upon the selection of the baking conditions. The anti-reflex effect of such layer systems depends, amongst other things decisively on the conditions during the baking process. Hereby the sol-gel layer is preferably already converted into its final form, so that additional after-treatment steps are not necessary.

In contrast to the method in accordance with DE 100 19 822 A1 no microstructures are produced in the present invention which could find use for example in semiconductor components and which for example become visible for the eye only under a microscope. According to the invention on the other hand, macro-structured areas, for example coarsely structured areas are produced. This means that structures in an order of magnitude to a minimum of 50 to 100 μm (corresponds approximately to the width of a hair) may be produced, so that always structures are produced which are visible to the eye. A conversion of such microstructures into macro-structures would not be considered by an expert, due to the known special position of the semiconductor technology.

According to an additional inventive variation, the application of the masking lacquer as a negative lacquer onto a substrate onto which a full-surface sol-gel layer has already been applied is possible (inventive method variation (b2)).

The evaporation of the solvent or drying in accordance with method variation (b2) is implemented preferably in a temperature range of ambient temperature to a maximum of 200° C., until essentially all solvents are removed whereby water, alcohol, solvents known to the expert, especially current, preferably halogen-free, low-boiling (boiling point: to 120° C.) and high-boiling solvents (boiling point: 120° to 250° C.) and mixtures are preferred. The drying time is generally in the range of a few minutes to 1 or more days. The above statements are intended as examples only, due to the dissimilarity of the layers that are to be produced.

Here too the structuring of the masking lacquer can be implemented advantageously by way of suitable (screen) printing processes, in other words by applying the masking lacquer in structured form, or photo-lithographically, that is after the application. The sol-gel layer is then removed from the exposed areas in second process step, for example with a suitable chemical caustic solution. A caustic solution of this type could be: an aqueous NaOH solution or an aqueous HF solution. Finally, the masking lacquer is again removed mechanically, chemically or pyrolytically—as already described.

The masking lacquer which is applied either in structured form or is structured following its application is advantageously not baked.

Any lacquer known to the expert, especially photo resist may be used as masking lacquer. Especially preferred are lacquer categories such as: masking lacquers, stripping lacquers, photo resists which can be structured (liquid resists, dry resists). Applicable commercially available products are for example masking lacquers 80 2039 (Ferro Company), Wepelan-masking lacquer SD 2154 E (Peters Company), stripping lacquer SD 2962 P (Peters Company), liquid resist AZ 9260 (Clariant Company), liquid resist AZ nLOF 2070 (Clariant Company), dry resist EtchMaster ES-102 (DuPont) and dry resist Riston 220 (DuPont).

The sol-gel solution used in accordance with the invention contains preferably additional components which are selected from the group consisting of inorganic and/or organic colorants, pigments and/or additives such as thickeners, disperging agents, defoaming agents, anti-precipitation agents, surface tension modifiers, auxiliary products, deaerators, slip additives and leveling agents, cross linking agents, primer and similar components. Additives may for example be utilized to create certain functionalities. By adding organic and/or inorganic colorants or pigments additional coloring effects can for example be produced. In addition, pigments are able to introduce additional functionalities into the layer, such as IR or UV reflection.

Use of a sol-gel solution including or consisting of the following components is especially preferred:
approximately 1 to approximately 80 weight % metal oxide, metal oxide precursor or metals such as SiO₂, alkoxy-silanes, alkyl-alkoxy-silanes, fluorinated alkyl-alkoxy-silanes, TiO₂, titanium-alkoxide, colloidal silver or colloidal silver compounds;
approximately 20 to approximately 99% weight solvents such as water, alcohols as well as all solvents known to the expert, especially current, preferably halogen-free, low-boiling (boiling point: to 120° C.) and high-boiling solvents (boiling point: 120° to 250° C.);
0 to approximately 20 weight % water for pre-condensing;
0 to approximately 5 weight % catalytic converter (acid, such as concentrated hydrochloric acid, sulphuric acid or nitric acid or caustic solution, such as caustic soda or caustic potash solution);
0 weight % to approximately 50 weight % coloration components, such as organic or inorganic colored pigments or organic colorants; and
0 weight % to approximately 10 weight % additive such as thickener, disperging agents, defoaming agent, anti-precipitation agents, surface tension modifier, auxiliary products, deaerators, slip additives and leveling agents, cross linking agents, primer etc.

The total volume of all components making up the sol-gel solution naturally amounts to 100 weight %.

The substrate in the above cited methods which is provided with one or more structures is not particularly limited according to the invention. Any material may be used, such as for example synthetic material, metal, wood, enamel, glass, ceramics, especially glass ceramics. Especially preferred are glass- and glass ceramics substrates. Alkaliferous float glasses, example borosilicate glasses (i.e. Borofloat 33, Borofloat 40, Duran by Schott A G, Mainz) as well as alkaline-free glasses (i.e. AF 37, AF 45 by Schott A G, Mainz), aluminosilicate glasses (i.e. Fiolx, Illax by Schott A G, Mainz), alkaline earth glasses (i.e. B 270, BK 7 by Schott A G, Mainz), Li₂O—Al₂O₃—SiO₂-Floatglass, bleached float glass having an iron concentration of less than 700 ppm, preferably less than 200 ppm find preferred use. Soda lime glasses are especially preferred for an even more special application. Also preferred are Display-glasses such as D263 by Schott-DESAG, Grüneplan. On principal, all technically and optically known glasses are usable.

Typical glass ceramics which find use as alkaline glass ceramics are for example lithium aluminosilicate (LAS) glass ceramics such as CERAN®, ROBAX® or ZERODUR® (all are trademarks of Schott AG, Mainz), however alkaline free glass ceramics such as magnesium aluminosilicate (MAS) may also be utilized.

The substrate is not especially limited within the scope of the invention, not only regarding the material but also regarding the form so that, for example, flat, circular, rounded large and small objects may be utilized. Preferred are objects of glass or containing glass and/or glass ceramic in any form such as glass tubes, glass lenses, ampoules, capsules, bottles, cans, panels, plates or arbitrarily formed components.

Naturally a surface treated substrate or one that is already furnished with a layer, such as for example surface treated or already coated glass can also be used. In this situation the substrate is furnished on at least a section of its surface with a macro-structure in accordance with the current invention. Obviously, the entire surface may also be structured, or the structure may occur in several sections of one or more surfaces. The structure may for example be applied on one or on two sides, or even on multiple sides, depending upon the form of the substrate.

The substrates listed below are cited simply as examples: tiles, enamel components, panels, especially viewing panels, plates, boards, glazing of all types, shower partitions, screens, work and cook surfaces, components of refrigerators and freezers, dining or drinking utensils, containers, protective fire panels, fireplace glass viewing panel, baking oven viewing panel, glass cover for solar energy plants, medical glass especially medicine bottles, viewing panels or covers for displays, a component of Hi-Fi or calculator or telecommunication devices, or similar products.

It is self-apparent that in addition to single layers, also multiple layer systems may be utilized to produce a desired macro-structure.

The partial or full surface macro-structured layers produced in accordance with the current invention are also object of the invention. These may for example find use in the form of functional layers, in other words, the partial or full surface structured layer possesses one or more special functions or characteristics. Examples for inventively structured functional layers are anti-reflex layers, ink layers, decorative layers, photo-catalytic layers, anti-microbial layers, anti-viral layers, anti-mold layers, anti-fungicide layers, anti-algae layers, anti-fogging-layers, cleaning layers, odor-neutralization layers, anti-fingerprint layers, air purification layers or combinations thereof.

The utilization of the inventive substrates, including a full or partial macro-structured layer is multifold. Examples are:
Tiles, such as ceramic, enamel or glass tiles;
Enamel components, especially baking oven muffles;
Plates, such as work plates i.e. glass or ceramic in the household or for labor;
Glazing of all types, especially windows, i.e. insulating glass doors for cupboards;
Picture frames;
Architectural glass;
Covers, for example for displays;
Basin lining, such as swimming pool lining, fish tanks;
Mirrors, i.e. retro-reflective traffic mirrors;
Walls, especially outside walls, i.e. of trains;
Shower partitions, i.e. glass or synthetic material;
panels, such as viewing panels, especially baking oven viewing panels, fireplace and microwave viewing panels;
Viewing windows;
Boards, such as advertising boards;
Kitchen utensils such as cutting boards, i.e. glass, ceramic, synthetics or wood;
Depositories, i.e. of glass, ceramic, synthetics or metal;
Cooking surfaces, for example glass ceramic cook-top surfaces;
Containers, such as baking cups;
Dining or drinking utensils, such as drinking glasses; and
Fittings for baking ovens, dish washers or refrigerators or freezes, for example refrigerator insert mats, compartments or drawers.

Additional application possibilities include for example glass ceramic panels for a household appliance, a glass cover for solar energy plants, viewing panel for dish washers or cooking utensils such as a steamer, protective fire screen or medical glass, for example medicine bottle, containers or tubes, for example coated containers or tubes for the dairy industry, viewing panel or cover for displays, component for Hi-Fi, calculator or telecommunication devices, for dining or drinking utensils, baby bottles, windows, optical lenses, laboratory glasses, especially borosilicate glasses.

Below we cite a few application examples for structured sol-gel layers or substrates which are provided with these:
One example are cost effective anti-reflex-layers (low cost AR). These may for example be produced from a colloidal SiO₂-sol through immersion. Structuring of the layers occurs predominantly in the edge areas of the substrates/components in order to simplify or even facilitate their installation into the overall system.
Anti-reflex layer systems can be produced. Known glass anti-reflection coatings for the visible spectral region are for example AMIRAN- or MIROGARD anti-reflection coatings by Schott AG. Interference filters of for example three layers, whereby initially one layer having a medium refractive index is deposited, followed by a layer having a high refractive index, usually TiO₂, followed by a layer having a low refractive index, usually SiO₂. Therefore, a 3- or 5-layer structure of low refractive SiO₂ and high refractive TiO₂ alternating layers is preferred in the current invention. Production occurs preferably with Si- and Ti-containing sols by way of immersion. Sheet glass with this type of coating is normally used as architectural glass or as glazing in a picture frame. The structuring of the layer system serves predominantly decorative purposes—for example the application of a logo. The desired optical effect can occur through structuring of one or several layers in the system, preferably the last layer in the system, or by applying an additional layer in structured form.
An additional application example demonstrates a colored rear-sided coating on a transparent glass ceramic. It is produced preferably originating from a pigment filled sol-gel ink. On principle the color can be adjusted with various viscosities so that in addition to the already described application methods of low-viscosity sol-gel solution such as especially spraying and pouring, screen printing techniques can also be utilized in suitable instances. Rear-sided coating of glass ceramics is used, for example in cook-top applications.
The structuring of the layers in this example serves the displayability as well as decorative purposes.
Tinted transparent coatings may also be produced. Here, the production occurs preferably based on a siliceous sol in which organic colorants are dissolved. Transparent tinted layers are intended predominantly for decorative purposes. The same applies to their structuring.
Furthermore, photo-catalytic coatings are also possible. Examples are TiO₂ layers (Anatas), produced from a colloidal TiO₂-sol by way of immersion or casting. The layers possess self-cleaning characteristics and for this reason have a very wide range of application: anti-bacterial, anti-virus, anti-mould, anti-fungicide, anti-algae, anti-fogging, anti-fingerprint coating, odor-neutralization, air purification, etc. In this context photo-catalytic layers are for example applied to floor tiles, fish tanks, retro-reflective traffic mirrors, outside walls of trains, architectural glass etc. In these instances the structuring of the layer serves predominantly to facilitate the installability of the coated components in overall systems or presents even a prerequisite for same.
Anti-microbial coatings may also be provided in accordance with the current invention. These are produced preferably from an Ag-containing, colloidal sol, by way of immersion. Components coated this way may be utilized in refrigerators. The structuring in this example occurs predominantly at the edges and may facilitate the installability of the components into the system or may be a necessary prerequisite for this. In addition, the volume of the very expensive coating can thereby be limited to the relevant areas.
Additional examples are easy-to clean coatings. For this purpose surfaces of glasses and glass ceramics are modified, for example in a hydrosiliconization reaction with longer, perfluorinated carbon chains. Due to this the surface receives a hydrophobic character and can be easily cleaned due to the reduction in the surface energy. Components with easy-to-clean layers are utilized predominantly in the “White goods” area and there, predominantly in “hot” applications (continuous load to 300° C.). Specific examples are: Baking oven windows, baking cups, cook-top surfaces, etc. The structuring of the layers in these instances serves the purpose of facilitating installability (for example bonding) of the substrate/the components into the total system, or to even make it possible.

The advantages of the current invention are multifold. The current invention provides a substrate as well as a method to produce said substrate, whereby the advantages of the sol-gel technology can be exploited. In other words, structured, coated substrates can be produced in wet-chemical processes with low expenditure and at a low cost. The substrates are not particularly limited—especially preferred are glass and glass ceramics.

The sol-gel technology may be utilized in an unexpected manner to produce almost any desired structured substrate, whereby low-viscosity solutions can also be used. Nevertheless, distinct and non-spreading structures are produced. In addition, the viscosity of the sol-gel solution can be adjusted as desired, so that low-viscous as well as highly viscous sol-gel solutions can be utilized, permitting the best results to be achieved for each specific application.

For a structured application of the sol-gel solution we can refer back to already known application and print methods, so that no special devices need to be conceived and designed.

The sol-gel method permits an economic structuring of even large surfaces, whereby one can refer—amongst others—also to aqueous systems, so that the applied structures do not release toxic solvents, that they are totally inert and that they can be used also inside without hesitation.

A suitable variation can be selected from the three inventive method variations, thus providing great flexibility.

The advantage of structures of this type which are produced with a sol-gel method is also the good mechanical, thermal and photo-chemical stability which is often achieved, the possibility to produce at ambient temperatures and, if desired the high spectral transparency. An additional advantage of these sol-gel layers is to be found in that in most instances they do not represent a growth source for microorganisms since they are toxicologically as well as biologically completely inert. In its hardened state the inorganic sol-gel structure that is to be produced represents a structure that is free from contaminations. It is therefore also suitable for use in food contact.

The inventively utilized sol-gel methods make it possible to produce thin, glass-like, optionally colored functional layers in great diversity and structure. Tailor made structures which are relevant to specific applications can be produced.

The following design examples serve to illustrate the methods according to the invention. They are to be understood solely as possible exemplary processes, without limiting the invention to their content.

### DESIGN EXAMPLES

### Design Example 1

Transparent glass-ceramic cook-top with a displayable tinted rear-coating.

A displayable rear-sided coating has recesses on those locations of the cook-top where electronic indicators or light emitting diodes are located. This allows the electronic indicator elements on the cook-top to be more easily visible. The structuring of the coating is realized in that the cook-top is initially masked with a masking lacquer at the desired locations. As a rule a sufficiently viscous and thixotropic lacquer (i.e. Wepelan-masking lacquer, Peters Co., stripping lacquer SD 2962, Peters Co. or stripping lacquer 80 2039, Ferro Co.) is used and applied by way of screen printing. Depending upon the specific type of lacquer it is especially advantageous if it is baked (at temperatures of max. 200° C.) prior to subsequent process steps.

An example of a pigment filled sol-gel ink (color tone rose) which is capable of being sprayed is given below:

Production of the Fixing Agent:
44.3 g Tetraethyl-orthosilicate (TEOS)
25.7 g n-propanol
19.5 g distilled water
8.9 g ethylene glycol
1.8 g concentrated hydrochloric acid (37%)

All ingredients are added and the mixture is stirred for 3 hours.

Production of the Color:
100 g fixing agent
35.7 g Iriodin 103 Rutil sterling silver
3.6 g Bayferrox 180
7.1 g Aerosil 0X50

Pigments and fillers are stirred into the fixing agent by way of stirring with a dissolver disk. In order to adjust the sprayability the ink is treated with an additional 43.0 g n-propanol as a solvent.

The pigment filled sol-gel ink is subsequently applied to the full surface of the substrate, for example by way of a spraying or pouring process and is air-dried for a sufficient amount of time.

Depending upon the type of masking lacquer used, said lacquer is then again removed by way of a suitable method. This is accomplished for example through treatment of the layer with an organic solvent (i.e. acetone) or mechanically through stripping. The display fields are now exposed. Under suitable conditions the structured layer is finally baked.

### Design Example 2

### Antireflective Mirogard Glass Panel with Logo

In order to decorate an antireflective Mirogard-glass panel with a logo the anti-reflex effect of the AR 3-layer system is neutralized at those locations where the logo is to appear. This causes a so-called “contrast décor” (also referred to as “indirect decor”). The neutralization of the AR-effect is accomplished when the last—that is the low refractive SiO₂ layer—is relieved at the desired locations. This is realized by applying the siliceous sol with the assistance of the screen printing technology during the final coating step. The SiO₂ layer is applied directly in structured form. There is no further full surface coating.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a substrate including a layer, said method comprising the steps of:
providing that the layer is one of a full and a partial surface macro-structured layer;
applying a sol-gel solution in already structured form onto the substrate; and
at least one of drying and baking, resulting in a sol-gel layer.

2. The method of claim 1, wherein said applying is accomplished with a low viscous, sufficiently thixotrope said sol-gel solution with a printing process selected from one of digital printing, tampon printing, and offset printing.

3. The method of claim 2, wherein said digital printing is selected from one of airbrush and inkjet printing, using a Piezo technique.

4. The method of claim 1, wherein said applying is accomplished with a high viscous said sol-gel solution with a printing process selected from one of screen printing, tampon printing, offset printing, and letterpress printing.

5. The method of claim 1, wherein said sol-gel layer includes a plurality of components selected from the group consisting of at least one of a) at least one of an inorganic and an organic colorant, b) a pigment, and c) an additive, said additive including at least one of a thickener, a disperging agent, an auxiliary product, a defoaming agent, a deaerator, an anti-precipitation agent, a surface tension modifier, a slip additive, a leveling agent, a cross linking agent, and a primer.

6. The method of claim 1, wherein the substrate includes at least one of a synthetic material, a metal, a wood, an enamel, a glass, and a ceramic material.

7. The method of claim 1, wherein the substrate is transparent.

8. The method of claim 1, wherein the substrate is structured one of one-sided and two-sided.

9. The method of claim 1, wherein said sol-gel solution includes at least one inorganic metal oxide including at least one of titanium-oxide, zircon-oxide, silicon-oxide, aluminum-oxide, tin-oxide, boron-oxide, and phosphorous-oxide.

10. The method of claim 1, wherein said sol-gel solution includes:
approximately 1 to approximately 80 weight % one of metal oxide, metal oxide precursor, metal, and a plurality of metals;
approximately 20 to approximately 99 weight % solvent;
0 weight % to approximately 50 weight % one of coloration component and a plurality of coloration components; and
0 weigh % to approximately 10 weight % one of additive and a plurality of additives,
wherein all components of said sol-gel solution together amount to 100 weight %.

11. The method of claim 1, wherein said one of a full and a partial surface macro-structured layer is one of a) located on a plurality of interior areas of the substrate and recessed in a plurality of edge areas, and b) recessed in a plurality of interior areas of the substrate and located on a plurality of edge areas.

12. A method for producing a substrate including a layer, said method comprising the steps of:
providing that the layer is one of a full and a partial surface macro-structured layer; and
structuring a sol-gel layer which has been applied to the substrate, by using a masking lacquer.

13. The method of claim 12, further including:
applying said masking lacquer onto the substrate, one of in already structured form and in a form in which a structure is produced in said masking lacquer after applying said masking lacquer onto the substrate;
coating said masking lacquer with a sol-gel solution;
drying said sol-gel solution, resulting in a dried said sol-gel layer;
removing said masking lacquer one of mechanically, chemically, and pyrolytically; and
baking said dried sol-gel layer when a quality of said dried sol-gel layer is insufficient, resulting in a hardened said sol-gel layer.

14. The method of claim 13, wherein said baking is not performed when said quality of said dried sol-gel layer is sufficient.

15. The method of claim 13, wherein said masking lacquer, which is applied one of in already structured form and in said form in which said structure is produced in said masking lacquer after applying said masking lacquer onto the substrate, is subsequently baked.

16. The method of claim 13, wherein the temperature for drying said sol-gel solution is adjusted within a range of ambient temperature (25° C.) to 100° C.

17. The method of claim 13, wherein the temperature for baking said sol-gel solution is adjusted within a range of 250° C. to 600° C.

18. The method of claim 12, further including:
applying a sol-gel solution onto the substrate and producing said sol-gel layer through evaporation of a solvent;
applying said masking lacquer onto said sol-gel layer, one of in already structured form and in a form in which a structure is created in said masking lacquer after applying said masking lacquer onto said sol-gel layer;
removing said sol-gel layer on a plurality of exposed areas which are not covered with said masking lacquer using a chemical caustic solution;
removing said masking lacquer one of mechanically, chemically, and pyrolytically; and
when an unstructured, dried sol-gel layer has not already been baked, baking a structured, dried said sol-gel layer, resulting in a hardened sol-gel layer.

19. The method of claim 18, wherein said solvent in said sol-gel solution is selected from at least one of water, alcohol, a halogen-free solvent, a low-boiling solvent (boiling point to 120° C.), and a high-boiling solvent (boiling point 1200 to 250° C.).

20. The method of claim 12, wherein said masking lacquer is utilized in screen printable form.

21. The method of claim 12, wherein said masking lacquer is a photo resist.

22. The method of claim 21, further including creating a structure in said photo resist, said creating occurring after applying said photo resist onto the substrate by exposure and subsequent removal of a plurality of undesired areas, said plurality of undesired areas corresponding to a plurality of areas that are not to be lacquered.

23. The method of claim 12, further including removing said masking lacquer one of mechanically, chemically, and pyrolytically, said removing using at least one of stripping, wiping off, brushing off, dissolving with a solvent, and temperature.

24. A substrate, comprising:
at least one of a full and a partial surface macro-structured layer obtained by structuring a sol-gel layer that was applied onto the substrate using a masking lacquer.
